(19) United States
(12) Patent Application Publication
(10) Pub. No.: US 2022/0128983 A1
(43) Pub. Date: Apr. 28, 2022

(54) DEFECT PREDICTION METHODS, APPARAUTSES, ELECTRONIC DEVICES AND STORAGE MEDIA

(71) Applicants: Beijing Zhongxiangying Technology Co., Ltd., Beijing (CN); BOE Technology Group Co., Ltd., Beijing (CN)

(72) Inventors: Fan ZHANG, Beijing (CN); Haijin WANG, Beijing (CN); Jianmin WU, Beijing (CN); Hong WANG, Beijing (CN)

(73) Assignee: BOE Technology Group Co., Ltd., Beijing (CN)

(21) Appl. No.: 17/395,131

(22) Filed: Aug. 5, 2021

(30) Foreign Application Priority Data
Oct. 28, 2020 (CN) 202011176670.0

(51) Int. Cl. G05B 23/02; G06K 9/62; G06N 20/20

(52) U.S. Cl. CPC G05B 23/024; G05B 23/0283; G06K 9/623; G06N 5/003; G06K 9/6289; G06N 20/20; G06K 9/6257

(57) ABSTRACT

The present disclosure relates to defect prediction methods, apparatuses, electronic devices, and storage media. One of the methods includes: obtaining parameter data of equipment parameters of target equipment within a preset time period; where the parameter data includes values recorded at a preset interval for each of the equipment parameters when a product passes through the target equipment; obtaining fusion features indicating features of the target equipment based on the parameter data; inputting the fusion features into a preset prediction model; and obtaining a prediction result output by the preset prediction model, where the prediction result indicates whether the product is abnormal.

### CROSS REFERENCE TO RELATED APPLICATIONS

This application claims a priority of the Chinese patent application No. 202011176670.0, filed on Oct. 28, 2020, the entire content of which is incorporated herein by reference.

### TECHNICAL FIELD

The present disclosure relates to the field of data processing technology, and in particular to defect prediction methods, apparatuses, electronic devices and storage media.

### BACKGROUND

At present, a production line of product includes several process equipment, and a plurality of inspection stations are set up in the entire production line. The inspection stations are usually set after multiple process equipment. When a defect in a produced product is found at an inspection station, it is necessary to trace back to a process station and determine a process equipment. It takes a lot of time for managers to check each process equipment one by one. In addition, after determining the abnormal process equipment, managers need to spend a lot of time paying attention to the abnormal process equipment until abnormal operations in the process equipment are completely confirmed. In addition, products may be abnormal in one of the multiple process equipment in a process station, however, the abnormality is usually found in the last process equipment in the multiple process equipment, that is, it takes a certain amount of time from occurrence of the abnormality to the discovery of the abnormality. All the above conditions combined lead to a lot of time consumption to determine the equipment causing the defect.

### SUMMARY

The present disclosure provides defect prediction methods, apparatuses, electronic devices, and storage media.

According to a first aspect of embodiments of the present disclosure, there is provided a method of predicting defect, including:

obtaining parameter data of equipment parameters of target equipment within a preset time period; where the parameter data includes values recorded at a preset interval for each of the equipment parameters when a product passes through the target equipment;

obtaining respective fusion features indicating features of the target equipment based on the parameter data;

inputting the fusion features into a preset prediction model; and obtaining a prediction result output by the preset prediction model, where the prediction result indicates whether the product is abnormal.

Optionally, the preset prediction model includes one of the following: logistic regression, random forest, LightGBM, and Xgboost.

Optionally, obtaining parameter data of the equipment parameters of the target equipment within the preset time period includes:

obtaining a number of values in respective parameter data when different products pass through the target equipment; and

adjusting the number of values in the respective parameter data to a preset number.

Optionally, obtaining the respective fusion features indicating the features of the target equipment based on the parameter data includes:

for the parameter data of each equipment parameter, obtaining a statistical feature and a time-frequency feature of the parameter data; and

inserting the time-frequency feature into the statistical feature to fuse the statistical feature and the time-frequency feature to obtain a fusion feature indicating a feature of the target equipment.

Optionally, obtaining the time-frequency feature of the parameter data includes:

obtaining a time series corresponding to the parameter data;

decomposing the time series by wavelet packet decomposition into multiple frequency bands of a preset number of layers, where the preset number of layers comprises a designated layer;

reconstructing signals of the multiple frequency bands in the designated layer to obtain reconstructed signals; and

obtaining respective energy values of the frequency bands in the reconstructed signals, where a maximum energy value is used as the time-frequency feature of the parameter data.

Optionally, the method further includes:

obtaining, when the prediction result indicates that the product is abnormal, one or more candidate equipment parameters of the target equipment;

obtaining feature data of a target equipment parameter in the one or more candidate equipment parameters, where the target equipment parameter has a greatest impact on the product; and

outputting the one or more candidate equipment parameters and the feature data of the target equipment parameter.

Alternatively, obtaining the one or more candidate equipment parameters of the target equipment includes:

obtaining respective weight values of the equipment parameters of the target equipment based on the prediction model;

sorting the equipment parameters of the target equipment according to the weight values from high to low; and

determining one or more equipment parameters ranked in front as the one or more candidate equipment parameters.

Alternatively, the preset prediction model being a random forest, obtaining the one or more candidate equipment parameters of the target equipment, includes:

obtaining, based on preset out-of-bag data, a first out-of-bag data error of each decision tree in the random forest;

for each equipment parameter, adding noise interference to the preset out-of-bag data to change values of the equipment parameter of samples in the preset out-of-bag data, and obtaining the second out-of-bag data error of each decision tree in the random forest;

calculating importance of the equipment parameter based on the second out-of-bag data error, the first out-of-bag data error and a number of decision trees in the random forest; and

determining one or more equipment parameters ranked in front as the one or more candidate equipment parameters for the target equipment.

Optionally, the method further includes training the preset prediction model, including:

obtaining a training sample set; where the training sample set includes a plurality of training samples, and each of the plurality of training samples includes fusion features for a process equipment and a sample label;

inputting each of the training samples in the training sample set to one or more to-be-trained prediction models to obtain one or more trained prediction models; where the one or more to-be-trained prediction models include at least one of the following: Logistic regression, random forest, LightGBM or Xgboost;

obtaining an evaluation score of each of the one or more trained prediction models based on one or more preset evaluation indices;

determining a trained prediction model with a highest evaluation score as the preset prediction model.

Optionally, before obtaining the training sample set, the method further includes:

obtaining a proportion of defective points of each of produced products in an inspection station during a specified time period;

determining a sample classification of each of the produced products based on the proportion of defective points and a threshold, where the sample classification includes positive sample and negative sample; where the positive sample is a product with the proportion of defective points less than or equal to the threshold, and the negative sample is a product with the proportion of defective points greater than the threshold;

sorting importance of process equipment to determine process equipment causing a high incidence of negative samples as the target equipment.

According to a second aspect of embodiments of the present disclosure, there is provided an apparatus for predicting defect, including:

a parameter data obtaining module configured to obtain parameter data of equipment parameters of target equipment within a preset time period; where the parameter data includes values recorded at a preset interval for each of the equipment parameters when a product passes through the target equipment;

a fusion feature acquisition module configured to obtain respective fusion features indicating features of the target equipment based on the parameter data;

a prediction result obtaining module configured to input the fusion features into a preset prediction model to obtain the prediction result output by the preset prediction model, where the prediction result indicates whether the product is abnormal.

According to a third aspect of embodiments of the present disclosure, there is provided an electronic device, including:

one or more processors;

one or more memories for storing a computer program executable by the one or more processors;

where the one or more processors are configured to execute the computer program stored in the one or more memories to implement the above methods.

According to a fourth aspect of embodiments of the present disclosure, there is provided a computer-readable storage medium having an executable computer program stored thereon, when executed by one or more processors, causing the one or more processors to implement the above methods.

It should be understood that the above general description and the following detailed description are only exemplary and explanatory, and cannot limit the present disclosure.

### BRIEF DESCRIPTION OF DRAWINGS

The accompanying drawings, which are incorporated in and constitute a part of this specification, illustrate examples consistent with the present disclosure and, together with the specification, serve to explain the principles of the present disclosure.

FIG. 1 is a flow chart showing a method of predicting defect according to an example embodiment.

FIG. 2 is a flow chart of adjusting parameter data according to an example embodiment.

FIG. 3 is a flow chart of obtaining a fusion feature according to an example embodiment.

FIG. 4 is a flow chart of obtaining a time-frequency feature according to an example embodiment.

FIG. 5 is a flow chart showing obtaining a preset prediction model according to an example embodiment.

FIG. 6 is a flow chart showing another method of predicting defect according to an example embodiment.

FIG. 7 is a flow chart of obtaining candidate equipment parameters according to an example embodiment.

FIG. 8 is a block diagram showing an apparatus for predicting defect according to an example embodiment.

### DETAILED DESCRIPTION

Examples will be described in detail herein, with the illustrations thereof represented in the drawings. When the following descriptions involve the drawings, like numerals in different drawings refer to like or similar elements unless otherwise indicated. The exemplary described embodiments below do not represent all the embodiments consistent with the present disclosure. On the contrary, they are merely examples of apparatuses consistent with some aspects of the present disclosure as detailed in the appended claims.

This embodiment provides a method of predicting defect, which can be applied to various process equipment in the production line of OLED, MiniLED, LCD and other production lines or a system for predicting defect of the production line, to predict whether a produced product has a defect. In the following description, the process equipment is taken as an example, and the process equipment implementing the defect prediction method is called target equipment. For the convenience of description, the product being an OLED product is taken as an example.

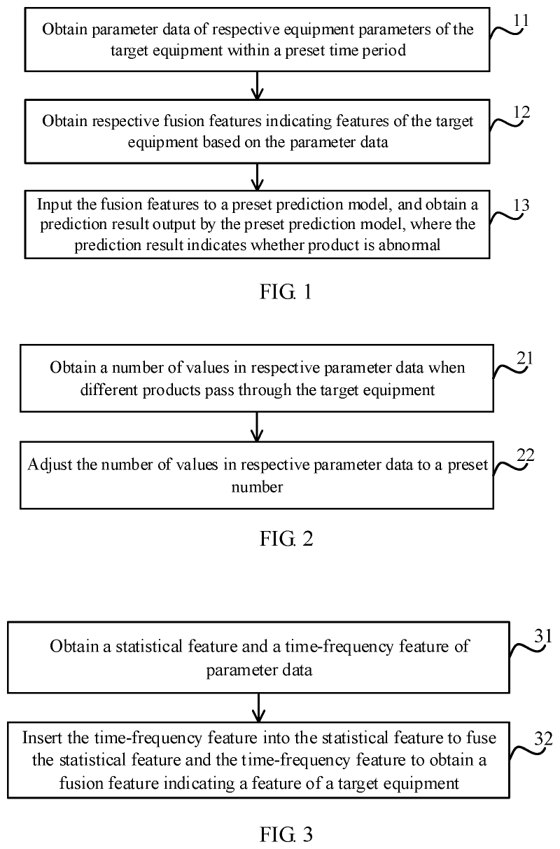

FIG. 1 is a flowchart of a method of predicting defect according to an example embodiment. Refer to FIG. 1, a method of predicting defect, includes steps 11 to 13.

At step 11, parameter data of respective equipment parameters of the target equipment within a preset time period is obtained.

In this embodiment, an OLED product production line can produce different types of display panels, and each type of display panels can pass through different process equipment (target equipment). For example, display panel A passes through process equipment (target equipment) a, b, c and d, while display panel B passes through the process equipment (target equipment) a, c, and d. In addition, different types of display panels require different equipment parameters when passing through a same process equipment. For example, display panel A requires a temperature of 36° C. when passing through process equipment a, and display panel B requires a temperature of 37° C. when passing through process equipment a. The equipment parameters can include but are not limited to: temperature, humidity, air pressure, stay time, etc. It is to be understood that during the production process, each equipment parameter is constantly changing during a period from entry of a product into the process equipment to departure of the product from the process equipment.

In this embodiment, the target equipment can obtain parameter data of each equipment parameter in the production process, and the parameter data can be expressed in time series. A number of values in the time series corresponding to parameter data of different equipment parameters of a same piece of equipment may be inconsistent. Taking two equipment parameters, temperature and humidity, in the equipment parameters as an example, the parameter data of the temperature parameter for producing display panel A is [36.1, 36.2, 36.2, 36.3, 36.1], and the parameter data of the humidity parameter for producing display panel A is [76.0, 76.2, 76.3, 76.3, 76.5, 76.7, 76.8]. In addition, when different products pass through a same piece of target equipment, the number of values in the time series corresponding to the same equipment parameter can also be inconsistent. Taking the temperature parameters for producing display panel A and display panel B as an example, because processes required to produce the two display panels are inconsistent, the time required for heating is different, resulting in inconsistent lengths of time series. For example, the parameter data of the temperature parameter for producing display panel A is [36.1,36.2,36.2,36.3,36.1], in which the number of values corresponding to the time series is 5, and the parameter data of the temperature parameter for producing display panel B is [36.0,36.2,36.3,36.3,36.5,36.7,36.8], in which the number of values corresponding to the time series is 7.

For the convenience of subsequent use, in this embodiment, the number of values in parameter data of each equipment parameter is pre-processed. Referring to FIG. 2, at step 21, a number of values in respective parameter data when different products pass through the target equipment is obtained. At step 22, the number of values in respective parameter data is adjusted to a preset number. That is to say, at steps 21 and 22, the number of values in each parameter data of different equipment parameters for the same piece of equipment can be adjusted to a same number. The adjustment method can be one of the following: adjusting to a maximum number of values in the time series, adjusting to an average number of values in the time series, or adjusting to a minimum number of values in the time series. In order to avoid losing part of data, in this embodiment, the number of values can be adjusted to the maximum number of values in the time series. The adjustment process includes: (1) determining the number of values in each time series; (2) selecting a maximum number of values in respective time series; (3) after the maximum number is determined, filling (for example, zero-padding) other time series having insufficient number of values, so that the numbers of data/values in all time series corresponding to the parameter data of different equipment parameters of the same equipment are the same.

At step 12, respective fusion features indicating features of the target equipment are obtained based on the parameter data.

In this embodiment, after obtaining the parameter data, the target equipment can obtain the fusion feature based on the parameter data. The fusion feature can be used to indicate the feature of the target equipment, and the fusion feature can be set according to a specific scenario. In an example, the fusion feature can include statistical feature and time-frequency feature. Referring to FIG. 3, obtaining the fusion feature includes steps 3132. At step 31, the statistical feature and the time-frequency feature of the parameter data are obtained; and at step 32, the time-frequency feature is inserted into the statistical feature to fuse the statistical feature and the time-frequency feature to obtain the fusion feature indicating the feature of the target equipment.

Taking the obtaining of statistical feature as an example, statistical feature can include at least one of the following features: Minimum value, Maximum value, Mean value, Median value, Standard deviation, Range, Index_max, Index_min, Stat_downtrend, Stat_uptrend, Slope, Positive_sum, Positive_max, Positive_maxstart, Positive_maxend, Negative_sum, Negative_max, Negative_maxstart, Negative_maxend. For example, in a case where a descending interval is [−3, −4], the interval is applicable to the following situations, where Negative_sum is −7, and Negative_maxstart is an index of −3, and Negative_maxend is an index of −4; in another case where the descending interval is [4, −4], the interval is applicable to the following situations, where Negative_sum is −4, Negative_maxstart is an index of −4, and Negative_maxend is an index of −4.

Time series A: [−2, 1, −1, 2, 3, −3, 4, −4] is taken as an example to describe the above-mentioned features:

Minimum value: −4;
Maximum value: 4;
Mean value: (−2+1+−1+2+3+−3+4+−4)/8=0;
Median value: data in the middle of a set of data arranged in order, for example, after sorting, the sequence of values in time series A is: −4, −3, −2, −1, 1, 2, 3, 4, and the Median value is (−1+1)/2=0;
Standard deviation:

$$std = \sqrt{\frac{1}{n - 1} {\sum }_{i = 1}^{8} {( {x}_{i} - \overline{x} )}^{2}} ,$$

calculated as 2.93;
Range: a difference between the maximum value and the minimum value, that is, the Range is 4−(−4)=8;
Index_min: an index of the minimum value, the index of −4 is 8;
Index_max: an index of the maximum value, the index of 4 is 7;
Stat_downtrend: a sum of one or more differences of downtrend, that is, a difference of interval [1, −1] is −1−1=−2, a difference of interval [3, −3] is −3-3=−6, a difference of interval [4, −4] is −4−4=−8, that is, the Stat_downtrend is −2−6−8=−16;
Stat_uptrend: a sum of one or more differences of uptrend, a difference of interval [−2, 1] is 1−(−2)=3, a difference of interval [−1, 2] is 2−(−1)=3, a difference of interval [2, 3] is 3−2=1, and a difference of interval [−3,4] is 4−(−3)=7, that is, the Stat_uptrend is 3+3+1+7=14;

### Slope:

$$α = \frac{\sum ( xy ) - \sum x \sum y}{n \sum {x}^{2} - {( \sum x )}^{2}} ,$$

that is, the Slope is −0.21428571;
Positive_sum: a sum of positive values, that is, the Positive_sum is 1+2+3+4=10;
Positive_max: a maximum value among sums of one or more rising intervals. The rising intervals are [−2, 1], [−1, 2], [2, 3], [−3, 4], where the interval with the maximum value of sum among the sums of the rising intervals is [2, 3]. The Positive_max is 2+3=5;
Positive_maxstart: a start index of an interval with the maximum value of sum among sums of consecutive rising intervals. In this case, this interval is [2, 3], and the index of 2 is 4;
Positive_maxend: an end index of an interval with the maximum value of sum among sums of consecutive rising intervals. In this case, this interval is [2, 3], and the index of 3 is 5;
Negative_sum: a sum of negative values, that is, the Negative_sum is −2−1−3−4=−10;
Negative_max: a negative value with a largest absolute value among sums of descending intervals. In this case, the Negative_max is −4;
Negative_maxstart: a start index of a negative value with a largest absolute value among sums of consecutive descending interval. −4 is the negative value with the largest absolute value among sums of consecutive descending interval, and the index of −4 is 8;
Negative_maxend: an end index of a negative value with a largest absolute value among sums of consecutive descending interval. −4 is the negative value with the largest absolute value among sums of consecutive descending interval, and the index of −4 is 8.
Based on the above-mentioned features, taking a form of [Minimum value, Maximum value, Mean value, Median value, Standard deviation, Range, Index_min, Index_max, Stat_downtrend, Stat_uptrend, Slope, Positive_sum, Positive_max, Positive_maxstart, Positive_maxend, Negative_sum, Negative_max, Negative_maxend, Negative_maxend] as an example, the statistical feature of time series A can be [−4,4,0,0,2.93,8,8,7,−16,14,−0.214,10,5,4,5,−10,−4,8,8].

By analogy, the target equipment can obtain statistical features corresponding to multiple parameter data of respective equipment parameters.

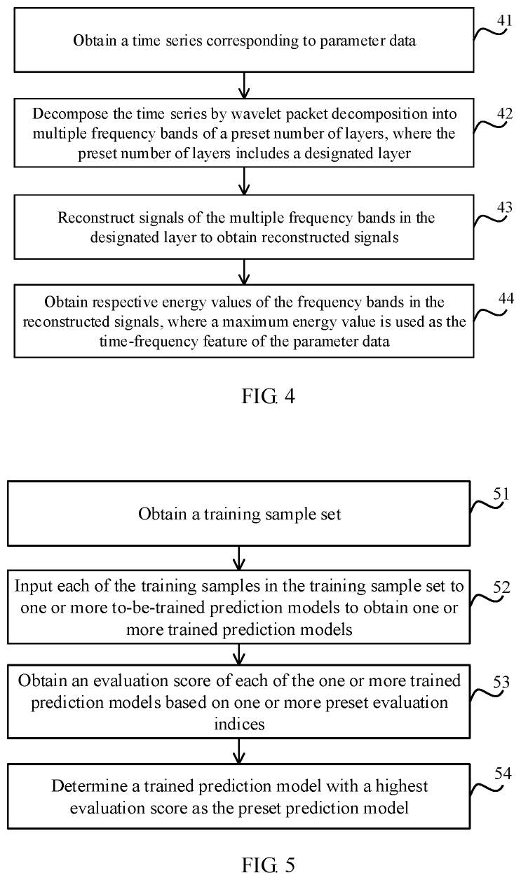

In this embodiment, the above-mentioned statistical features can only average features in a time series, but cannot characterize a time sequence feature or a feature of a certain time period. Therefore, the time-frequency feature can also be obtained in this embodiment. Referring to FIG. 4, at step 41, the target equipment can obtain a time series corresponding to parameter data. At step 42, the time series is decomposed by wavelet packet decomposition into multiple frequency bands of a preset number of layers, where the preset number of layers includes a designated layer. At step 43, signals of the multiple frequency bands in the designated layer can be reconstructed to obtain reconstructed signals. At step 44, respective energy values of the frequency bands in the reconstructed signals can be obtained, and a maximum energy value is used as the time-frequency feature of the parameter data.

In this embodiment, the wavelet packet decomposition is adopted, considering that the wavelet packet decomposition can decompose both a low-frequency part of the signal and a high-frequency part of the signal in the time series; and the above-mentioned decomposition has neither redundancy nor omissions, so that a signal containing a large amount of medium and high frequency information can be better analyzed in time-frequency localization, which is more suitable for actual needs of scenarios in this embodiment. As for how to perform the wavelet packet decomposition and the reconstruction, related technologies can be referred to, which will not be repeated here.

In an example, the wavelet packet decomposition is adopted, and taking the preset number of 3 and the designated layer as the third layer as an example, where obtaining time-frequency feature includes:

(1) obtaining a time series corresponding to parameter data of a single equipment parameter for each product;
(2) decomposing the time series by wavelet packet decomposition, where a number of decomposition layers is 3 layers, signals in a third layer decomposed by db6 wavelet packet function are (x₃₁, x₃₂, x₃₃, x₃₄, x₃₅, x₃₆, x₃₇, x₃₈);
(3) reconstructing signals of different frequency bands in the third layer to improve the time-frequency resolution, and the reconstructed signals are (y₃₁, y₃₂, y₃₃, y₃₄, y₃₅, y₃₆, y₃₇, y₃₈);
(4) constructing an energy feature vector for the reconstructed signals, where the energy of each frequency band E₃ⱼ=Σₙ₌₁^{N}|Y₃ⱼ|² (j=1, 2, . . . , 8), N is a number of signal sampling points, and then normalizing the energy feature vector, E=(Σⱼ₌₀⁷|E₃ⱼ|²)^{1/2}, Ē₃ⱼ=E₃ⱼ/E, taking a maximum value, namely a main frequency, as the time-frequency feature of the parameter data.

Based on the above steps, the time-frequency feature of time series A can be obtained as [0.721].

Then, the target equipment can fuse the statistical feature with the time-frequency feature. Continuing to take time series A as an example, the statistical feature of time series A is [−4,4,0,0,2.93, 8,8,7,−16,14,−0.214,10,5,4,5,−10,−4,8,8], the time-frequency feature is [0.721], and the fusion feature is [−4,4,0,0,2.93,8,8,7,−16,14,−0.214,10,5,4, 5,−10,−4,8,8,0.721].

In an embodiment, in order to eliminate a dimensional influence between the statistical feature and the time-frequency feature, the fusion feature needs to be normalized to make different indicators comparable. In this embodiment, Z-score can be used, and its formula is expressed as:

$$z = \frac{( x - μ )}{σ} ;$$

where, x is a specific value, μ is the mean value, and σ is the standard deviation.

When there are too many features, dimension of the features will be too large, so the dimension of the features is to be reduced. In this example, a Pearson correlation coefficient is used to calculate a closeness of a correlation between features. The formula is as follows:

$$r ( X , Y ) = \frac{Cov ( X , Y )}{{σ}_{X} {σ}_{Y}} ;$$

where, Cov(X, Y) is a covariance of X and Y, σₓ is a variance of X, σ_{Y} is a variance of Y. A value of the correlation coefficient is between −1 and +1, that is, −1 [symbol] +1. Generally, |r|<0.5 is low-degree correlation; 0.5<|r| is significant correlation.

That is, in this embodiment, by calculating the Pearson correlation coefficient between the features, part of the significantly correlated features can be eliminated, so as to achieve the purpose of feature dimensionality reduction.

At step 13, the fusion features are input to a preset prediction model, and a prediction result output by the preset prediction model is obtained, where the prediction result indicates whether a product is abnormal.

In this embodiment, the preset prediction model can be stored in the target equipment, and the preset prediction model is configured to predict whether the produced product is a normal product or an abnormal product based on the parameter data of respective equipment parameters of the target equipment. The preset prediction model is a kind of machine learning, which can be implemented by one of the following models: logistic regression, random forest, LightGBM, and Xgboost. In addition, the prediction model can be trained by the following manners, see FIG. 5, including steps 51 to 54.

At step 51, a training sample set is obtained. The training sample set includes a plurality of training samples, and each of the plurality of training samples includes fusion features for a process equipment and a sample label. At this step, in the actual production process of OLED products, when the process equipment causing defects is determined, the parameter data of respective equipment parameters of the process equipment (target equipment) within a time period can be obtained according to step 11, and fusion features of respective parameter data of the plurality of equipment parameters can be obtained according to step 12, so as to obtain sample data. Then, according to a proportion of defective points in a produced OLED product, it is determined that the fusion features of the parameter data of the equipment parameters are the positive sample or the negative sample. When the fusion features are the positive sample, the sample label of the fusion features is set to 1; when the fusion features are the negative sample, the sample label of the fusion features is set to −1, so as to obtain the training samples including the fusion features of equipment parameters of the process equipment and sample labels.

It should be noted that determining the process equipment causing defects in this step can be implemented by the following ways: a defect analysis system can be set up in a production line, and the defect analysis system can first create samples for a certain time period, specify an inspection station, defect and other related information, and divide the samples into positive and negative sample data. A proportion of defective points or a ratio of defective points to normal points on each display panel is used as an indicator for distinguishing the positive and negative samples. If the proportion of defective points or the ratio of defective points to normal points is greater than a threshold, the sample is a negative sample; if the proportion of defective points or the ratio of defective points to normal points is less than the threshold, the sample is a positive sample. Additionally or alternatively, an intelligent mining module can be set up in the production line, and the intelligent mining module can be used to obtain the parameter data when the display panel passes through the process equipment in the production process (for example, in the time period used to create samples). Decision-tree-based algorithms (such as ID3, C4.5, CART, etc.) are used to analyse the parameter data, and importance of process equipment is sorted, so as to determine equipment causing a high incidence of negative samples as the target equipment.

Of course, after the equipment with the high incidence of negative samples is determined, managers can continue to trace back until all equipment causing the high incidence of negative samples is completely determined. After determining the equipment with the high incidence of negative samples, step 51 is performed on the equipment.

At step 52, each of the training samples in the training sample set is input to one or more to-be-trained prediction models to obtain one or more trained prediction models. At this step, the one or more to-be-trained prediction models include, for example, 3 prediction models. In an example, the one or more to-be-trained prediction models include at least one of the following: logistic regression, random forest, LightGBM, or Xgboost. The training sample set can be divided into training set, validation set and test set at a ratio of 8:1:1. In this way, the training set can be input to each to-be-trained prediction model, and the validation set and the test set can be used for validation or testing. After the prediction model is validated, it can be determined that the prediction model has completed training. Processes for using the training sample set to train the prediction model can refer to related technologies, which will not be repeated here.

At step 53, an evaluation score of each of the one or more trained prediction models is obtained based on one or more preset evaluation indices. At this step, the evaluation indices of the prediction model can be preset, and the evaluation indices include but are not limited to: accuracy rate, precision rate, recall rate, etc., which are used to analyze credibility of each prediction model.

TABLE 1
prediction results of the prediction model

| | prediction: | prediction: |
|---|---|---|
| | positive sample | negative sample |
| Actual: positive sample | TP | FN |
| Actual: Negative sample | FP | TN |

Note:
TP (True Positive) represents a number of positive samples predicted as positive samples; FN (False Negative) represents a number of positive samples predicted as negative samples; FP (False Positive) represents a number of negative samples predicted as positive samples; TN (True Negative) indicates a number of negative samples predicted as negative samples.

The accuracy rate calculation formula is as follows:

Accuracy=(TP+TN)/(TP+FN+FP+TN);

The precision rate calculation formula is as follows:

Precision=TP/(TP+FP);

The formula for calculating the recall rate of positive samples is as follows:

Recall=TP/(TP+FN).

At this step, after the evaluation indices are determined, the evaluation scores of the one or more trained prediction models can be calculated.

At step 54, a trained prediction model with a highest evaluation score is determined as the preset prediction model. At this step, the evaluation scores can be sorted from high to low to determine the trained prediction model with the highest evaluation score as the preset prediction model.

In this embodiment, in a process of producing a product, after the target equipment obtains the fusion features, the fusion features can be input to the above-mentioned prediction model, and the prediction model outputs the prediction result, which can indicate whether the OLED product is abnormal, or in other words, the prediction result can indicate whether the produced OLED product is abnormal in the subsequent process based on current working state of the target equipment. It is convenient for managers to determine whether the target equipment is working properly based on the prediction result, and timely maintenance can be carried out when target equipment is working abnormally.

In an embodiment, after determining that the target equipment is working abnormally, the equipment parameters causing defects are to be determined. See FIG. 6, the method includes steps 61 to 63.

At step 61, when the prediction result indicates that the product is abnormal, one or more candidate equipment parameters of the target equipment are obtained; where the candidate equipment parameters are used to assist in analyzing causes of product abnormality/defect.

The one or more candidate equipment parameters can be obtained through steps 71 to 73.

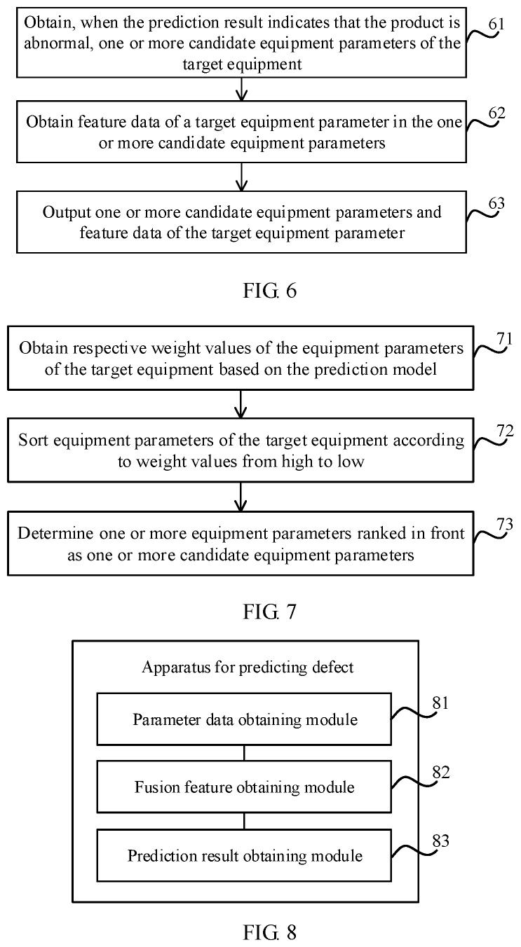

Referring to FIG. 7, at step 71, the target equipment may obtain respective weight values of the equipment parameters of the target equipment based on the prediction model. Taking logistic regression as an example, the weight value of each feature in the statistical feature of the parameter data of the equipment parameter can be obtained by calculating absolute value of regression coefficient of each variable. In practical applications, a weight value calling function (e.g., feature_importances function) can be set for each prediction model. After the training is completed, weight value or importance of each feature can be obtained by directly calling the above weight value calling function. Taking importance of a feature X in the random forest as an example: 1) for each decision tree in the random forest, corresponding OOB (Out-Of-Bag) data is used to calculate the feature X out-of-bag data error, which is denoted as errOOB1, that is, the first out-of-bag data error; 2) noise interference is randomly added to the feature X (that is, the feature in the statistical feature of the parameter data of the equipment parameter) of all samples of the out-of-bag data OOB, at this time, the value of the feature X in the sample can be randomly changed; and the out-of-bag data error, denoted as errOOB2, can be calculated again, which is the second out-of-bag data error; 3) assume that there are N trees in the random forest, then the importance of feature X is Σ(errOOB2−errOOB1)/N.

With reference to the importance of the feature X, the importance of all features in the statistical feature of the parameter data of all equipment parameters of the target equipment can be sorted, and one or more features (for example, the maximum value, minimum value, mean value, etc. in the statistical feature) with a higher importance can be obtained, so that one or more equipment parameters (for example, temperature, humidity, etc.) that are more important and have a greater impact on the target equipment can be obtained.

It should be noted that the reason why this expression can be used as a measure of the importance of corresponding features in this example is because: when noise is randomly added to a feature in a statistical feature, if an out-of-bag accuracy rate is greatly reduced, it shows that this feature has a great influence on a classification result of the sample, that is to say, the feature is relatively important.

In another example, at step 71, the target equipment may obtain a weight value of each equipment parameter of the target equipment based on the prediction model. Taking logistic regression as an example, the weight value of each equipment parameter can be obtained by calculating absolute value of regression coefficient of each variable. In practical applications, a weight value calling function (e.g., feature_importances function) can be set for each prediction model. After the training is completed, weight value or importance of each equipment parameter can be obtained by directly calling the above weight value calling function. Taking importance of an equipment parameter Y in the random forest as an example: 1) for each decision tree in the random forest, corresponding OOB (Out-Of-Bag) data is used to calculate out-of-bag data error of the equipment parameter, which is denoted as errOOB1, that is, the first out-of-bag data error; 2) noise interference is randomly added to the equipment parameter Y of all samples of the out-of-bag data OOB, at this time, the value of the equipment parameter Y in the sample can be randomly changed; and the out-of-bag data error, denoted as errOOB2, can be calculated again, which is the second out-of-bag data error; 3) assume that there are N trees in the random forest, then the importance of the equipment parameter Y is Σ(errOOB2−errOOB1)/N.

With reference to the importance of the equipment parameter Y, the importance of all the equipment parameters of the target equipment can be sorted, and one or more equipment parameters with a higher importance can be obtained, that is, one or more equipment parameters (for example, temperature, humidity, etc.) that are more important and have a greater impact on the target equipment can be obtained.

It should be noted that the reason why this expression can be used as a measure of the importance of corresponding equipment parameter in this example is because: when noise is randomly added to an equipment parameter, if an out-of-bag accuracy is greatly reduced, it shows that this equipment parameter has a great influence on a classification result of the sample, that is to say, the equipment parameter is relatively important.

At step 72, equipment parameters of the target equipment can be sorted according to weight values from high to low.

At step 73, one or more equipment parameters ranked in front are determined as one or more candidate equipment parameters. In an example, a number of candidate equipment parameters is 10, which can be adjusted according to specific scenarios.

At step 62, feature data of a target equipment parameter in the one or more candidate equipment parameters can be obtained, where the target equipment parameter has a greatest impact on the product.

At step 63, one or more candidate equipment parameters and feature data of the target equipment parameter can be output to assist user in determining causes of the product abnormality/defect. In this way, the manager can check the one or more candidate equipment parameters first, so as to quickly determine the equipment parameter causing the abnormality/defect. In addition, the manager can also evaluate the prediction results of the prediction model based on check results of one or more candidate equipment parameters. In other words, this embodiment not only provides a prediction model for predicting product quality, but also increases interpretability of the prediction model by providing one or more candidate equipment parameters, so that managers can adjust equipment parameters in time to avoid losses, and adjust the prediction model to improve accuracy of the prediction results.

So far, in the embodiments of the present disclosure, the parameter data of each equipment parameter of the target equipment within the preset time period can be obtained; where the parameter data includes values recorded at a preset time interval for each equipment parameter when the product passes through the target equipment; then, fusion features indicating features of the target equipment can be obtained based on the parameter data; after that, the fusion features can be input to a preset prediction model to obtain a prediction result output by the preset prediction model, where the prediction result indicates whether the product is abnormal. In this way, whether the product produced during production process is abnormal can be predicted, so that the manager can adjust the target equipment in advance to improve the production yield.

FIG. 8 is a block diagram illustrating an apparatus for predicting abnormality/defect according to an example embodiment. Referring to FIG. 8, an apparatus for predicting abnormality/defect, includes:

a parameter data obtaining module 81 configured to obtain parameter data of equipment parameters of target equipment within a preset time period; where the parameter data includes values recorded at a preset interval for each of the equipment parameter when a product passes through the target equipment;

a fusion feature obtaining module 82 configured to obtain respective fusion features indicating features of the target equipment based on the parameter data;

a prediction result obtaining module 83 configured to input the fusion features into a preset prediction model to obtain a prediction result output by the preset prediction model, where the prediction result indicates whether the product is abnormal.

It is to be understanded that the apparatus provided in the embodiments of the present disclosure corresponds to the above-mentioned method, and the specific content can refer to the content of each embodiment of the method, which will not be repeated here.

In an example embodiment, an electronic device is provided, including:

one or more processors;

one or more memories for storing a computer program executable by the one or more processors;

where, the one or more processors are configured to execute the computer program in the one or more memories to implement steps of the above-mentioned defect prediction method.

In an example embodiment, there is also provided a computer-readable storage medium including executable instructions, for example, a memory including executable instructions, and the executable instructions can be executed by one or more processors to implement steps of the above-mentioned defect prediction method. Among them, the computer-readable storage medium can be a ROM, a random-access memory (RAM), a CD-ROM, a magnetic tape, a floppy disk, an optical data storage device, etc. In addition, the readable storage media can be volatile or non-volatile.

In practical applications, the computer-readable storage medium may be any combination of one or more computer-readable media. The computer-readable media may be computer-readable signal media or computer-readable storage media. The computer-readable storage media may be, for example, but not limited to, electrical, magnetic, optical, electromagnetic, infrared, or semiconductor systems, apparatuses or devices, or any combination thereof. More specific examples (a non-exhaustive list) of the computer-readable storage media may include: electrical connections with one or more wires, portable computer disks, hard disks, random access memories (RAMs), read-only memories (ROMs), erasable programmable read-only memories (EPROMs or flash memories), optical fibers, portable compact disk read-only memories (CD-ROMs), optical storage devices, magnetic storage devices, or any suitable combination thereof. In this embodiment, the computer-readable storage media may be any tangible media that contain or store a program, which may be used by or in combination with an instruction execution system, apparatus, or device.

The computer-readable signal media may include data signals propagated in baseband or as a part of a carrier wave, in which computer-readable program codes are carried. The data signals propagated as such may be in many forms, including but not limited to electromagnetic signals, optical signals, or any suitable combination thereof. The computer-readable signal media may also be any computer-readable media other than the computer-readable storage media, which may send, propagate, or transmit the program for use by or in combination with the instruction execution system, apparatus, or device.

The program codes contained in the computer-readable media may be transmitted by any suitable medium, including but not limited to wireless, wire, optical cable, RF, etc., or any suitable combination thereof.

The computer program codes used to perform the operations in the present disclosure may be written in one or more programming languages or a combination thereof. The programming languages may include object-oriented programming languages such as Java, Smalltalk, C++, and also include conventional procedural programming languages such as C language or similar programming languages. The program codes may be executed completely on a user's computer, executed partially on the user's computer, executed as an independent software package, executed partially on the user's computer and partially on a remote computer, or executed completely on the remote computer or server. In the case of the remote computer, the remote computer may be connected to the user's computer through any kind of network, including a local area network (LAN) or a wide area network (WAN), or may be connected to an external computer (for example, through the Internet using an Internet service provider).

Those skilled in the art will easily think of other embodiments of the present disclosure after considering the specification and practicing the disclosure disclosed herein. The present disclosure is intended to cover any variations, uses, or adaptive changes that follow the general principles of the present disclosure and include common knowledge or conventional technical means in the technical field that are not disclosed in the present disclosure. The description and the embodiments are to be regarded as exemplary only, and the true scope and spirit of the present disclosure are pointed out by the following claims.

What is claimed is:

1. A method of predicting defect, comprising:
obtaining parameter data of equipment parameters of target equipment within a preset time period; wherein the parameter data comprises values recorded at a preset interval for each of the equipment parameters in response to that a product passes through the target equipment;
obtaining respective fusion features indicating features of the target equipment based on the parameter data;
inputting the fusion features into a preset prediction model; and
obtaining a prediction result output by the preset prediction model, wherein the prediction result indicates whether the product is abnormal.

2. The method of claim 1, wherein the preset prediction model comprises one of the following: logistic regression, random forest, LightGBM, and Xgboost.

3. The method of claim 1, wherein obtaining parameter data of the equipment parameters of the target equipment within the preset time period comprises:
obtaining a number of values in respective parameter data in response to that different products pass through the target equipment; and
adjusting the number of values in the respective parameter data to a preset number.

4. The method of claim 1, wherein obtaining the respective fusion features indicating the features of the target equipment based on the parameter data comprises:
for the parameter data of each equipment parameter,
obtaining a statistical feature and a time-frequency feature of the parameter data; and
inserting the time-frequency feature into the statistical feature to fuse the statistical feature and the time-frequency feature to obtain a fusion feature indicating a feature of the target equipment.

5. The method of claim 4, wherein obtaining the time-frequency feature of the parameter data comprises:
obtaining a time series corresponding to the parameter data;
decomposing the time series by wavelet packet decomposition into multiple frequency bands of a preset number of layers, wherein the preset number of layers comprises a designated layer;
reconstructing signals of the multiple frequency bands in the designated layer to obtain reconstructed signals; and
obtaining respective energy values of the frequency bands in the reconstructed signals, wherein a maximum energy value is used as the time-frequency feature of the parameter data.

6. The method of claim 1, further comprising:
obtaining, in response to that the prediction result indicates that the product is abnormal, one or more candidate equipment parameters of the target equipment;
obtaining feature data of a target equipment parameter in the one or more candidate equipment parameters, wherein the target equipment parameter has a greatest impact on the product; and
outputting the one or more candidate equipment parameters and the feature data of the target equipment parameter.

7. The method of claim 6, wherein obtaining the one or more candidate equipment parameters of the target equipment, comprises:
obtaining respective weight values of the equipment parameters of the target equipment based on the prediction model;
sorting the equipment parameters of the target equipment according to the weight values from high to low; and
determining one or more equipment parameters ranked in front as the one or more candidate equipment parameters.

8. The method of claim 6, wherein the preset prediction model being a random forest, obtaining the one or more candidate equipment parameters of the target equipment, comprises:
obtaining, based on preset out-of-bag data, a first out-of-bag data error of each decision tree in the random forest;
for each equipment parameter,
adding noise interference to the preset out-of-bag data to change values of the equipment parameter of samples in the preset out-of-bag data, and obtaining a second out-of-bag data error of each decision tree in the random forest;
calculating importance of the equipment parameter based on the second out-of-bag data error, the first out-of-bag data error and a number of decision trees in the random forest; and
determining one or more equipment parameters ranked in front as the one or more candidate equipment parameters for the target equipment.

9. The method of claim 1, further comprising:
training the preset prediction model comprising:
obtaining a training sample set; wherein the training sample set comprises a plurality of training samples, and each of the plurality of training samples comprises fusion features for a process equipment and a sample label;
inputting each of the training samples in the training sample set to one or more to-be-trained prediction models to obtain one or more trained prediction models; wherein the one or more to-be-trained prediction models comprise at least one of the following: Logistic regression, random forest, LightGBM or Xgboost;
obtaining an evaluation score of each of the one or more trained prediction models based on one or more preset evaluation indices;
determining a trained prediction model with a highest evaluation score as the preset prediction model.

10. The method of claim 9, wherein before obtaining the training sample set, the method further comprises:
obtaining a proportion of defective points of each of produced products in an inspection station during a specified time period;
determining a sample classification of each of the produced products based on the proportion of defective points and a threshold, wherein the sample classification comprises positive sample and negative sample; wherein the positive sample is a product with the proportion of defective points less than or equal to the threshold, and the negative sample is a product with the proportion of defective points greater than the threshold;
sorting importance of process equipment to determine process equipment causing a high incidence of negative samples as the target equipment.

11. An electronic device, comprising:
one or more processors;
one or more memories for storing a computer program executable by the one or more processors;
wherein, the one or more processors are configured to execute the computer program stored in the one or more memories to:
obtain parameter data of equipment parameters of target equipment within a preset time period; wherein the parameter data comprises values recorded at a preset interval for each of the equipment parameters in response to that a product passes through the target equipment;
obtain respective fusion features indicating features of the target equipment based on the parameter data;
input the fusion features into a preset prediction model; and
obtain a prediction result output by the preset prediction model, wherein the prediction result indicates whether the product is abnormal.

12. The electronic device of claim 11, wherein the one or more processors are configured to execute the computer program stored in the one or more memories to:
obtain a number of values in respective parameter data in response to that different products pass through the target equipment; and
adjust the number of values in the respective parameter data to a preset number.

13. The electronic device of claim 11, wherein the one or more processors are configured to execute the computer program stored in the one or more memories to:
for the parameter data of each equipment parameter,
obtain a statistical feature and a time-frequency feature of the parameter data;
insert the time-frequency feature into the statistical feature to fuse the statistical feature and the time-frequency feature to obtain a fusion feature indicating a feature of the target equipment.

14. The electronic device of claim 13, wherein the one or more processors are configured to execute the computer program stored in the one or more memories to:
obtain a time series corresponding to the parameter data;
decompose the time series by wavelet packet decomposition into multiple frequency bands of a preset number of layers, wherein the preset number of layers comprises a designated layer;
reconstruct signals of the multiple frequency bands in the designated layer to obtain reconstructed signals; and
obtain respective energy value of the frequency bands in the reconstructed signals, wherein a maximum energy value is used as the time-frequency feature of the parameter data.

15. The electronic device of claim 11, wherein the one or more processors are configured to execute the computer program stored in the one or more memories to:
obtain, in response to that the prediction result indicates that the product is abnormal, one or more candidate equipment parameters of the target equipment;
obtain feature data of a target equipment parameter in the one or more candidate equipment parameters, wherein the target equipment parameter has a greatest impact on the product; and
output the one or more candidate equipment parameters and the feature data of the target equipment parameter.

16. The electronic device of claim 15, wherein the one or more processors are configured to execute the computer program stored in the one or more memories to:
obtain respective weight values of the equipment parameters of the target equipment based on the prediction model;
sort the equipment parameters of the target equipment according to the weight values from high to low; and
determine one or more equipment parameters ranked in front as the one or more candidate equipment parameters.

17. The electronic device of claim 15, wherein the preset prediction model being a random forest, the one or more processors are configured to execute the computer program stored in the one or more memories to:
obtain, based on preset out-of-bag data, a first out-of-bag data error of each decision tree in the random forest;
for each equipment parameter,
add noise interference to the preset out-of-bag data to change values of the equipment parameter of samples in the preset out-of-bag data, and obtain a second out-of-bag data error of each decision tree in the random forest;
calculate importance of the equipment parameter based on the second out-of-bag data error, the first out-of-bag data error and a number of decision trees in the random forest; and
determine one or more equipment parameters ranked in front as the one or more candidate equipment parameters for the target equipment.

18. The electronic device of claim 11, wherein the one or more processors are configured to execute the computer program stored in the one or more memories to:
train the preset prediction model comprising:
obtaining a training sample set; wherein the training sample set comprises a plurality of training samples, and each of the plurality of training samples comprises fusion features for a process equipment and a sample label;
inputting each of the training samples in the training sample set to one or more to-be-trained prediction models to obtain one or more trained prediction models; wherein the one or more to-be-trained prediction models comprise at least one of the following: Logistic regression, random forest, LightGBM or Xgboost;
obtaining an evaluation score of each of the one or more trained prediction models based on one or more preset evaluation indices;
determining a trained prediction model with a highest evaluation score as the preset prediction model.

19. The electronic device of claim 18, wherein, before obtaining the training sample set, the one or more processors are configured to execute the computer program stored in the one or more memories to:
obtain a proportion of defective points of each of produced products in an inspection station during a specified time period;
determine a sample classification of each of the produced products based on the proportion of defective points and a threshold, wherein the sample classification comprises positive sample and negative sample; wherein the positive sample is a product with the proportion of defective points less than or equal to the threshold, and the negative sample is a product with the proportion of defective points greater than the threshold;
sort importance of process equipment to determine process equipment causing a high incidence of negative samples as the target equipment.

20. A computer-readable storage medium having an executable computer program stored thereon, when executed by one or more processors, causing the one or more processors to:
obtain parameter data of equipment parameters of target equipment within a preset time period; wherein the parameter data comprises values recorded at a preset interval for each of the equipment parameters in response to that a product passes through the target equipment;
obtain respective fusion features indicating features of the target equipment based on the parameter data;
input the fusion features into a preset prediction model; and
obtain a prediction result output by the preset prediction model, wherein the prediction result indicates whether the product is abnormal.
